(19) United States
(12) Patent Application Publication
(10) Pub. No.: US 2023/0235171 A1
(43) Pub. Date: Jul. 27, 2023

(54) POLYMER COMPOSITE COMPRISING BISCUIT CEREAL MEAL

(71) Applicant: CODA Intellectual Property B.V., s'Gravenhage (NL)

(72) Inventor: Daniel Eric Lynch, Rotterdam (NL)

(73) Assignee: CODA Intellectual Property B.V., s'Gravenhage (NL)

(21) Appl. No.: 18/193,372

(22) Filed: Mar. 30, 2023

Related U.S. Application Data
(63) Continuation of application No. PCT/NL2021/050593, filed on Sep. 29, 2021.

(30) Foreign Application Priority Data
Sep. 30, 2020 (NL) 2026595

(51) Int. Cl. C08L 67/04; C08K 5/00; C08K 3/013; C08J 3/20; C08L 23/12; C08K 11/00

(52) U.S. Cl. CPC C08L 67/04; C08K 5/0016; C08K 3/013; C08J 3/203; C08L 23/12; C08K 11/00; C08J 2323/12; C08J 2367/04

(57) ABSTRACT

The invention concerns a polymer composite comprising:
a. polymer in an amount of 1-99% by weight of the overall weight;
b. biscuit cereal meal in an amount of at least 1% by weight of the overall weight;
c. optional plasticizer in an amount from 0-50% w/w of component b);
d. optional filler, and
e. optional additive.

The invention also concerns a process for its preparation, an intermediate, and a solid article comprising the polymer composite.

### CROSS REFERENCE TO RELATED APPLICATIONS

This application is a continuation of International Application No. PCT/NL2021/050593, filed on 29 Sep. 2021, which claims priority to Netherlands Application No. 2026595 NL, filed 30 Sep. 2020, the contents of each of which are hereby incorporated by reference in their entirety herein.

### TECHNICAL FIELD

This invention concerns a polymer composite comprising biscuit cereal meal.

### BACKGROUND

Every day, in bakeries and mills, bread, cakes and cereals are left on the shelves. Biscuit waste, also referred to as biscuit meal or biscuit cereal meal (herein after BCM) is a product processed from bakery products such as biscuits, confectionery, crisps and snacks, breakfast cereals and cereal food products that are manufactured for human consumption. It is a dry product that has undergone a cooking process. This waste product is frequently used as cattle feed, in view of its greater feed digestibility and feed efficiency than unprocessed grains. For instance, BCM is suitable for supplementary feeding or as an ingredient in total mixed rations for poultry, pig, dairy and beef cattle.

BCM will differ from supplier to supplier and even from batch to batch, since prepared from a mixed source. The product generally meets the following description:

| Composition | Range | Typical |
|---|---|---|
| Dry matter (DM) | >85% | >87% |
| Protein | 6-12% | 7-11% |
| Energy (Metabolisable | 12-16 MJ/kg DM | 13-15 MJ/kg DM |
| Energy) | | |
| Crude fibre | 2-8% | 3-6% |
| FAT | 4-10% | 5-8% |
| Natural Detergent | 8-20% | 9-18% |
| Fibre (NDF) level | | |
| Starch | 20-60% | 30-50% |
| Sugars | 8-20% | 10-12% |

Note that BCM is commercially available in many grades. For information on different grades, cf, Corassa, Anderson. (2014). Biscuit meal composition in pig feeding. Comunicata Scientiae. 5. 106-109.

For the purpose of the present invention, BCM is considered to be any product produced from the bakery, confectionery, breakfast cereal, cake and snack food industries with the addition of wheatfeed. Typically, and preferably, it is a mixture of 0-100% products from breakfast cereal manufacture with 100-0% products from the bakery and pasta industries that has been ground and sieved to make a free-flowing meal. Additional food additives may be added, such as sugars, flavourings, flagrances and the like, but preferably the BCM is without such food additives.

BCM is not the same as biscuit flour, which is an ingredient that may be ideal to make cookies and biscuits due to a relatively low gluten content. Biscuit flour thus relates to a component that can be used in combination with a wide variety of other ingredients to prepare dough prior to undergoing a cooking or baking process to make finished cookies and biscuits.

US2012/135169A1 discloses in one of the examples the use of different flours, including biscuit flour, for making a polymer composition.

GB1584387 also discloses the use of different types of flour including biscuit flour and cereal flour by-products, which are by-products when producing cereal flour.

As alternative to its use as cattle feed, it has now been found that BCM can be used, even at high levels of inclusion, to prepare a polymer composite. The purpose of such is to either reduce fossil fuel based plastic content and/or create biodegradable/compostable composites with similar polymers.

Polymer composites comprising BCM are novel. The purpose of the present invention is to find new polymer composites with a reduced fossil fuel based plastic content, without loss of strength or flexibility. Moreover, the purpose of the present invention is to find polymer composites that can be moulded, e.g., into disposable articles such as coffee capsules, cutlery, straws, drink stirrers, food trays, single-serve packaging, such as a cup, cap, container and/or lid, or any other single-use item, etc., i.e. with sufficient strength to form a disposable article with a wall thickness larger than 250 micrometres.

### SUMMARY OF THE INVENTION

A polymer composite is provided as claimed in claim 1, comprising.
a. polymer in an amount of 1-99% by weight of the overall weight;
b. biscuit cereal meal (BCM) produced from baked cereal products in an amount of at least 1% by weight of the overall weight;
c. optional plasticizer in an amount from 0-50% w/w of component b);
d. optional filler, and
e. optional additive.

Also provided is a process for preparing the polymer composite, an intermediate for preparing the polymer composite and articles comprising the polymer composite.

### DETAILED DESCRIPTION OF THE INVENTION

It has been found that with the optional addition of a plasticizer, optionally together with an appropriate compatibilizer, the BCM can form a plastic composite material with a polymer. It can do this even at high loading levels, e.g., higher than 20% w/w or even higher than 30% w/w based on the BCM and polymer, with sufficient strength to form a disposable article with a wall thickness larger than 250 micrometres (10 mils).

For use in the present invention, any type of BCM as defined above can be used as component b). This current invention specifically focusses on BCM with 10-15% protein, 60-70% starch, and 0-5% sugar. Prior to compounding, the bakery by-products are milled to a fine powder, having a particle size smaller than 1 mm, preferably smaller than 500 micrometres. This is preferably done in multiple stages to obtain a uniform small particle size.

Milling is preferably carried out on dry material e.g. in order to more easily obtain a uniform small particle size and/or to reduce the amount of introduced liquid such as water. In an embodiment, materials may thus be dried prior to milling. Hence, although in this specification, materials may only be referred to as being milled, the present invention alternatively or additionally refers to embodiments in which the materials are dried milled and thus, if necessary, the wording “milled” may be replaced throughout the specification by the wording “dried milled” where appropriate. In other words, “milled” has to be interpreted as meaning “milled and/or dried milled” unless specifically stated otherwise.

The BCM may be used at low loading levels, starting at 1% w/w on the combination of components a) and b), but preferably is used at loading levels in excess of 20% w/w, e.g., at loading levels of 20-90% w/w, more preferably at loading levels of 20-80%, still more preferably at loading levels of 20-70% w/w. The BCM may be mixed, e.g. up to 100%, preferably up to 50% by weight of component b), with milled expeller/meal/cake, milled pomace, milled distillers' grain, milled brewer's grain (or brewer's spent grain/draff), coffee grounds, milled whole seeds, milled whole roots, milled whole beans, milled stems and/or leaves, whole grain flour of cereal grass, and flour of pulse, or combinations thereof. For instance, a mixture of two materials such as BCM and either borage meal, or canary seed powder may be used. When mixing the BCM with expellers, meals, and the like, the amount of plasticizer, if any, can be calculated on either the weight of the expellers, meals, and the like alone, or it can be calculated on the combined (total) weight of the BCM mixture, dependent on the specific mixture.

Suitable expellers may include but are not limited to the expeller of sunflower seeds, rapeseed, linseed, peanut, palm fruit, sesame seed, castor seed, and sugar beet pulp.

Suitable meals may include but are not limited to the meal of sunflower, borage, cottonseed, Buglossoides arvensis (Ahiflower), safflower, rosehip, canola, blackcurrant, palm kernel, rapemeal, and evening primrose. Cereal grasses include staple crops such as maize, wheat, rice, barley, oat and millet and hybrids such as triticale, as well as feed for animals, such as canary seeds. Pulses include annual leguminous crops yielding from one to twelve grains or seeds of variable size, shape and colour within a pod, that are used for both food and feed and that are harvested solely for dry seed, such as field peas, faba beans and lupin beans. Suitable examples of pomace may include grape pomace, olive pomace, apple pomace, or the solid remains of other fruits or vegetables after pressing for juice or oil.

The polymer composite may be made from any polymer as component a), but preferably a thermoplastic polymer is used. Suitable polymers include synthetic and natural polymers, e.g., biobased and biodegradable polymers. Suitable thermoplastic materials include polyamides (such as nylon), acrylic polymers, polystyrenes, polypropylene (PP), polyethylene (including low-density polyethylene (LDPE) and high density polyethylene (HDPE), acrylonitrile butadiene styrene (ABS), polyglycolic acid, polycarbonates, polybenzimidazole, poly ether sulphone, polyether ether ketones (PEEK), polyetherimide, polyphenylene oxide, polyphenylene sulphide, polyvinyl chloride, and polytetrafluoroethylene, or any suitable mixture thereof.

Elastomers, or combinations of thermoplastic polymers with elastomers may also be used. Suitable elastomers include natural and synthetic rubbers, chloroprene, neoprene, isoprene, polybutadiene, butyl rubber, halogenated butyl rubber, styrene-butadiene, nitrile rubber, latex, fluoroelastomers, silicone rubbers, epichlorhydrin, poly ether block amides, ethylene vinyl acetate (EVA) and ethylene vinyl alcohol (EVOH) for example. The elastomer may comprise a thermoplastic elastomer, which may be selected from styrenic block copolymers (TPE-s), thermoplastic olefins (TPE-o), elastomeric alloys (TPE-v or TPV), thermoplastic polyurethanes (TPU), thermoplastic copolyester (TPE-E) and thermoplastic polyamides, for example.

Thermoset polymers, or combinations of thermoplastic polymers with thermoset polymers may also be used. Suitable thermoset polymers include epoxy resins, melamine formaldehyde, polyester resins and urea formaldehyde, for example.

Suitable acrylic polymers (which may be thermoplastics, thermosets or thermoplastic elastomers) include polyacrylic acid resins, polymethyl methacrylates, polymethyl acrylates, polyethyl acrylates, polyethyl ethacrylates, and polybutyl methacrylates, for example.

Suitable polyesters include polyglycolide (PGA), polylactide or poly(lactic acid) (PLA), poly(lactide-co-glycolide) (PLGA), polycaprolactone (PCL), poly(butylene succinate) (PBS) and its copolymers, e.g. poly(butylene succinate-co-adipate) (PBSA), poly(butylene adipate-co-terephtalate) (PBAT), a linear copolymer of N-acetyl-glucosamine and N-glucosamine with β-1,4 linkage, cellulose acetate (CA), poly(hydroxybutyrate) (PHB) or other polyhydroxyalkanoates (PHA), poly(hydroxybutyrate-co-hydroxyvalerate) (PHBV), or any suitable mixture thereof. Most preferably either PLA or PBS is used as component a). Most preferably, for improved biodegradability, the polymer composite comprises either PLA or PBS in an amount between 30-50% w/w of the overall mixture.

To avoid degradation of the BCM or BCM mixture, a polymer may be used which may be processed at a temperature up to 215° C., preferably up to 210° C., more preferably up to 185° C., and most preferably up to 180° C.

BCMs used in the polymer composites of the present invention, may or may not be aided by the use of either a plasticizer or a compatibilizer, for instance, at high loading levels of 20% w/w, or 30% w/w, and greater. Plasticizers are an important class of low molecular weight non-volatile compounds that are widely used in polymer industries as additives. Plasticizers for thermoplastics are, in general, high boiling point liquids, with average molecular weights of between 300 and 600, and linear or cyclic carbon chains (14-40 carbons). However, the purpose of the plasticizer for a biomaterial is to prevent agglomeration of the carbohydrate/protein chains so that the biomaterial mixes with the polymer and the two become a single plastic mass. For the purpose of the present invention, the plasticizer must be compatible with component b), and be different from component b).

The plasticizer may be liquid or solid or a combination thereof. Preferably it is a solid plasticizer, more preferably selected from polyols, polyfunctional alcohols, amphipolar plasticizers such as carboxylic acids and esters, for instance mono, di-, and tri-glyceride esters; mono-, di- and oligosaccharides and combinations thereof. Polyols have been found to be particularly effective. Suitable plasticizers include water, glycerol, ethylene bisformamide, urea, citric acid, citrate/lipid mixtures, galactose, adipic acid, fructose, trimethylolpropane, urea, tartaric acid, xylose, xylitol, ethyleneglycol, polyethyleneglycol (PEG), triethyleneglycol (TEG), tetraethyleneglycol (TEEG), triethanolamine, ethanolamine, diethanolamine, sorbitol, maltitol, sucralose, threitol, erythritol, psicose, allose, talose, ribitol, tagatose, arabinose, galactitol, lactitol, arabitol, glyceraldehyde, iditol, sorbose, ribose, galactose, volemitol, mannitol, fucitol, xylose, xylitol, trehalose, cellobiose, raffinose, glucose, mannose, fructose, isomalt, polydextrose and sucrose; and/or combinations thereof. The present invention may require the use of a solid plasticizer or a mixture of a solid plasticizer and a liquid plasticizer with a melting temperature in the range of 55-210° C., preferably in the range of 70 to 210° C., more preferably in the range 80 to 210° C., and most preferably in the range 90 to 210° C. The amount of liquid plasticizer may be small, e.g. up to 10% by weight of component c). For instance, xylose, with a melting point of 144-145° C. and/or sorbitol, with a melting point of 94-96° C., and/or xylitol, with a melting point of 92-96° C. may be used. An advantage of using sorbitol over xylose is the higher tensile strength of the resulting polymer composite. An advantage of using xylitol over sorbitol is the higher tensile strength of the resulting polymer composite. Further, xylitol has a lower solubility in water then sorbitol and xylose meaning that when the polymer composite is used in solid articles that during use are subjected to water, e.g., hot water, as in a coffee machine, the chance of xylitol being dissolved into the water is lower.

The plasticizer may be used in an amount from 15-50% w/w of component b), preferably between 22-40% w/w of component b).

Additional, optional components of the polymer composite include fillers, such as mineral fillers and/or natural fibres and/or carbon-based fillers.

Suitable mineral fillers include carbonates (including bicarbonates), phosphates, ferrocyanides, silica, silicates, aluminosilicates (including all forms of clay minerals, mica and talc), titanium dioxide, or combinations thereof. For instance, a nepheline syenite may be used or any similar filler derived from silica-undersaturated and peralkaline igneous rocks, as well as any type of bentonite.

Natural fibres include cellulose or lignocellulosic fibres such as plant or vegetable fibres from the blast, leaf, seed, wood, or stem. For instance, wood cellulose fibre may be used.

Carbon based fillers include carbon nanotubes (CNT), graphene, fullerene, graphite, and amorphous carbon.

The filler may be used in an amount from 0-96% w/w of the overall mixture, preferably between 1-40% w/w of the overall mixture.

Optional additional components include compatibilizers, fragrances, heat and UV stabilizers, colouring agents and the like. Suitable compatibilizers include any acrylic grafted thermoplastics (for example: maleic anhydride grafted polyethylene, polypropylene, or polylactic acid), interface-active high-molecular-weight peroxides, poly(2-ethyl-2-oxazoline), any esters of citric acid, aromatic carbodiimides (for example: BioAdimide from Lanxess), wax-based emulsion additives (for example: Aquacer from BYK Additives), organo-silane coupling agents, and isocyanate (or diisocyanate) coupling agents (for example: methylenediisocyanate).

The additional components may be used in an amount from 0-30% by weight of the overall mixture, preferably between 0-15% by weight of the overall mixture.

The polymer composite is made by so-called “hot compounding” techniques, where the components are combined under heat and shearing forces that bring about a state of molten plastic (fluxing) which is shaped into the desired product, cooled and allowed to develop ultimate properties of strength and integrity. Hot compounding includes calendering, extrusion, injection and compression moulding. This is carried out at temperatures, pressures and processing conditions specific to the selected polymer. For instance, when using PLA the temperature is preferably in the range of 130 to 215° C., more preferably in the range of 130 to 210° C., even more preferably between 130 to 185° C., most preferably between 130 to 165° C.

The polymer composite may also be made by a multistep process, wherein the BCM is first compounded with the plasticizer, liquid and/or solid, and pelletized and the pellets or grinded pellets are then combined with the polymer. Additional components may be added in any of the steps of the multistep process. The present invention therefore also provides pellets or grinded pellets of BCM compounded and pelletized with plasticizer and other components if any, as intermediate product for combination with the polymer to produce the polymer composite.

The result of the process can be in the form of a solid article (or layer or portion thereof) and may comprise a compounded pellet, extruded work-piece, injection-moulded article, blow moulded article, rota-moulded plastics article, two-part liquid moulded article, laminate, 3D printer filament, felt, woven fabric, knitted fabric, embroidered fabric, nonwoven fabric, geotextiles, fibres or a solid sheet, for example.

The solid article can be in the form of a coffee capsule, cutlery, straw, drink stirrer, food tray, or single-serve packaging, such as a cup, cap, container and/or lid, or any other single-use item.

In an embodiment, the solid article may comprise a polyolefin, e.g. PP and/or PE, at a loading level of 1-30% w/w.

The solid article is preferably suited to be used and/or cleaned in water environments with a temperature above room temperature, preferably a temperature above 30° C., more preferably a temperature above 50° C., even more preferably a temperature above 60° C., and most preferably a temperature above 80° C. The solid article may for instance be used in a coffee machine using water at a temperature between 80 to 100° C., e.g., between 87 and 92° C.

The solid article is preferably suited to be used under pressure, e.g., a pressure above 2 bar, preferably a pressure above 4 bar, more preferably a pressure above 6 bar, and most preferably a pressure above 8 bar, e.g. as used in a coffee machine.

The solid article preferably has a minimum thickness above 250 micrometres, preferably above 350 micrometres, more preferably above 500 micrometres, and most preferably above 600 micrometres.

The invention is illustrated by the below examples.

### Example 1

275 grams of PLA (Ingeo® 3251 D from Natureworks LLC), 225 grams of biscuit cereal meal powder milled in a laboratory grain mill grinder (sieved through a 1 mm sieve) and 67.5 grams of xylose (sieved through a 1 mm sieve) was mixed in a sealed plastic bag into a homogenous mixture (Mixture 1).

### Example 2

275 grams of PLA (Ingeo 3251 D from Natureworks LLC), 225 grams of biscuit cereal meal powder milled in a laboratory grain mill grinder (sieved through a 1 mm sieve) and 67.5 grams of sorbitol (sieved through a 1 mm sieve) was mixed in a sealed plastic bag into a homogenous mixture (Mixture 2).

### Example 3

275 grams of PLA (Ingeo 3251 D from Natureworks LLC), 225 grams of biscuit cereal meal powder milled in a laboratory grain mill grinder (sieved through a 1 mm sieve) and 67.5 grams of xylitol (sieved through a 1 mm sieve) was mixed in a sealed plastic bag into a homogenous mixture (Mixture 3).

### Example 4

250 grams of EcoVio® A1652 (a PLA/PBAT blend from BASF plc), 250 grams of biscuit cereal meal powder milled in a laboratory grain mill grinder (sieved through a 1 mm sieve) was mixed in a sealed plastic bag into a homogenous mixture (Mixture 4).

### Example 5

350 grams of PP (Sabic® 578L) and 150 grams of biscuit cereal meal powder milled in a laboratory grain mill grinder (sieved through a 1 mm sieve) was mixed in a sealed plastic bag into a homogenous mixture (Mixture 5).

### Example 6

325 grams of PP (Sabic 578L), 150 grams of biscuit cereal meal powder milled in a laboratory grain mill grinder (sieved through a 1 mm sieve) and 25 grams of Fusabond™ M603 (maleic anhydride grafted polyethylene as compatibilizer from Dow Inc.) was mixed in a sealed plastic bag into a homogenous mixture (Mixture 6).

### Example 7

325 grams of PP (Sabic 578L), 75 grams of biscuit cereal meal powder milled in a laboratory grain mill grinder (sieved through a 1 mm sieve), 75 grams of Hifill™ N800 (nepheline syenite powder as inorganic filler from Sibelco UK Ltd) and 25 grams of Fusabond™ M603 was mixed in a sealed plastic bag into a homogenous mixture (Mixture 7).

### Examples 8-11

Mixtures 1-4 (from Examples 1-4) were individually poured into the hopper of a Negri Bossi v55 injection molding machine with a 32 mm diameter screw and a L/D ratio of 20:1 operating at temperatures ranging from 130 to 185° C. Each molten plasticized mixture was injection moulded in a single-cavity tool fitted with a single-drop hotrunner system into capsules suitable for use in a Nespresso®-style coffee machine.

### Examples 12-14

Mixtures 5-7 (from Examples 5-7) were individually poured into the hopper of a Negri Bossi v55 injection moulding machine with a 32 mm diameter screw and a L/D ratio of 20:1 operating at temperatures ranging from 165 to 185° C. Each molten plasticized mixture was injection moulded in a twin-cavity tool fitted with a single-drop hotrunner system into drink stirrer sticks suitable for stirring beverages.

### Example 15

10 kgs of biscuit cereal meal powder was run through a Magico EMC70 electric mill from AMA S.p.A. fitted with a 1 mm sieve to break up any agglomerated clumps. The resultant powder was then compounded with EcoVio IA1652 in a ratio of 50:50 on a Werner and Pfleiderer ZSK 25 twin-screw compounder fitted with a ZS-B 25 twin-screw side feeder. The screw profile used is given in Table 1 along with the respective injection points for the component materials. The temperature settings along the barrel were 170, 190, 170, 170, 170, 170, 170, 170° C. The compounded filament was cooled in a water bath, dried under an air knife and pelletized using a SG-E 60 from Intelligent Pelletizing Solutions GmbH & Co KG. Pellets were dried overnight in a Dryplus 250 from Vismec s.r.l at 80° C.

TABLE 1
Screw profile with material inclusion points

| | | |
|---|---|---|
| Conveying | 16/16 | (EcoVio) |
| | 36/36 (×2) | |
| | 36/18 | |
| | 36/36 | |
| | 36/18 | |
| Kneading | 45/5/36 | |
| | 45/5/18 | |
| | 45/5/18 (×2) | |
| Conveying | 36/36 (×5) | (Biscuit cereal meal) |
| Kneading | 45/5/36 (×3) | |
| Conveying | 36/36 | |
| Kneading | 45/5/24 (×3) | |
| Conveying | 16/16 | |
| | 36/36 (×2) | |
| Kneading | 45/5/12 (×2) | |
| | 90/5/24 | |
| Conveying | 36/36 | |
| Kneading | 45/5/12 (×2) | |
| | 45/5/12 | |
| Conveying | 36/36 (×5) | |
| | 24/24 (×4) | |

### Example 16

9.2 kgs of biscuit cereal meal powder was run through a Magico EMC70 electric mill from AMA S.p.A. fitted with a 1 mm sieve to break up any agglomerated clumps. This powder was then mixed in a tumble mixer with 800 grams of whole blue field pea powder that had been milled in a laboratory grain mill grinder. The resultant mixture was then compounded with EcoVio IA1652 in a ratio of 50:50 on a Werner and Pfleiderer ZSK 25 twin-screw compounder fitted with a ZS-B 25 twin-screw side feeder. The screw profile used is given in Table 1 and the respective injection points for the component materials were as per Example 15. All other details were as per Example 15.

### Example 17-18

Compounded pellets from Examples 15 and 16 were fed into the hopper of a Krauss Maffei 120-180 PX injection molding machine with a 25 mm diameter screw operating at temperatures ranging from 200 to 215° C. Each molten plasticized mixture was injection moulded in an eight-cavity tool fitted with a valve-gate hotrunner system into capsules suitable for use in a Nespresso-style coffee machine.

### Example 19

Representative coffee capsules from Examples 8-11 were filled to level capacity with ground coffee grains and sealed with self-sealing aluminium coffee capsule lids. Filled pods were then tested in a standard Nespresso coffee machine to produce a volume of filtered coffee. All capsules tested produced approximately the same volume of coffee as expelled from a commercial Nespresso capsule.

### Example 20

Representative coffee capsules from Examples 17-18 were filled to level capacity with ground coffee grains and sealed using Green Capsule top lids (Ahlstrom-Munksjö Oyj) on a laboratory rig with a heated ring that could be lowered and raised in an appropriate position to bond the pre-cut circular lid film to the rim of the coffee capsule. Filled capsules were then tested in a standard Nespresso coffee machine to produce a volume of filtered coffee. All capsules tested produced approximately the same volume of coffee as expelled from a commercial Nespresso capsule.

### Example 21

20 kgs of compounded pellets containing BioPBS FZ71PM (PTT MCC Biochem Company Ltd) and biscuit cereal meal powder (that had been run through a Magico EMC70 electric mill from AMA S.p.A. fitted with a 1 mm sieve) in a ratio of 70:30 respectively were prepared on a Werner and Pfleiderer ZSK 25 twin-screw compounder fitted with a ZS-B 25 twin-screw side feeder as per Example 15 except that all of the barrel temperatures were set 10° C. higher.

### Example 22

Compounded pellets from Example 19 were fed into the hopper of a Krauss Maffei 120-180 PX injection molding machine with a 25 mm diameter screw operating at temperatures ranging from 180 to 200° C. The molten plasticized mixture was injection moulded in a two-cavity tool fitted with a thermal gate hotrunner system into flip-top caps.

### Example 23

Fifteen representative coffee capsules from Example 17 (weight: 2.72±0.01 g) were mixed into 2 kgs of commercially purchased topsoil (passed through a 4 mm sieve) containing enough distilled water to saturate (defined by not leaving any standing water) the soil in a 5 L Pyrex glass beaker covered with 20 cm diameter watch glass. The beaker was placed inside a Unitemp temperature controlled oven set at 58° C. (as per the thermophilic incubation period as detailed in ISO20200-2015). The trial was left undisturbed for separate periods of 21 days up to a total of 90 days.

Upon extraction and cooling to room temperature of the glass beaker at the end of each 21 day trial period, the soil was carefully broken apart to extract any intact capsules. Following extraction of both capsules and the larger pieces of broken capsules the soil was again sifted through a 4 mm sieve to extract any remaining pieces. All capsules were dried and then carefully brushed with a toothbrush to remove any attached dirt before being photographed and returned to re-saturated soil for another 21 day trial period until the end of the 90 day trial period. At the end of the 90 day trial period all capsules had disintegrated into pieces with less than 15% by weight not passing through a 4 mm sieve.

### SUMMARY

Examples 1-5, 15 and 21 illustrate polymer composites with a high loading of biscuit cereal meal. In Example 6 the combination of biscuit cereal meal with a compatibilizer is illustrated. In Example 7, filler materials have been used and Example 16 with flour of pulse.

The formulations were used in the preparation of a disposable article, in this case a coffee capsule (Examples 8-11, and 17-18), a drink stirrer stick (Examples 12-14), or a flip-top cap (Example 22). The coffee capsules were strong enough to be used in a Nespresso® coffee machine, as shown in Examples 19-20. Moreover, the coffee capsules made from BCM and biodegradable plastics proved to be highly biodegradable, as shown in Example 23.

The invention can be summarized by the following clauses:
1. Polymer composite comprising:
   a. polymer in an amount of 1-99% by weight of the overall weight;
   b. biscuit cereal meal (BCM), in an amount of at least 1% by weight of the overall weight;
   c. optional plasticizer in an amount from 0-50% w/w of component b);
   d. optional filler, and
   e. optional additive.
2. Polymer composite as claimed in clause 1, wherein component a) comprises a biodegradable polymer, preferably PLA, or derivatives or polymer blends thereof.
3. Polymer composite as claimed in clause 2, wherein component a) is present in an amount of 30-70% by weight of the overall weight, preferably in an amount of 30-50% by weight of the overall weight.
4. Polymer composite as claimed in any of the preceding clauses, wherein component b) comprises BCM with a 10-15% protein, 60-70% starch, and 0-5% sugar content.
5. Polymer composite as claimed in any of the preceding clauses, comprising a mixture of BCM and up to 50% w/w of component b) of milled expeller/meal/cake, milled pomace, milled distillers' grain, milled brewer's grain (or brewer's spent grain/draff), milled whole seeds, milled whole roots, milled whole beans, milled stems and/or leaves, milled whole grain flour of cereal grass, flour of pulse, or a mixture thereof.
6. Polymer composite as claimed in any of the preceding clauses, wherein component b) or the mixture of clause 5 is present in an amount of 30-70% by weight of the overall weight.
7. Polymer composite as claimed in any of the preceding clauses, comprising polyols, polyfunctional alcohols, amphipolar plasticizers such as carboxylic acids and esters, for instance mono, di-, and tri-glyceride esters; mono-, di- and oligosaccharides, or mixtures thereof, as component c).
8. Polymer composite as claimed in any of the preceding clauses, wherein component c) is present in an amount from 22 to 40% w/w of component b).
9. Polymer composite as claimed in any of the preceding clauses, comprising as component d) either a natural fibre, preferably cellulose or lignocellulose fibres, and/or a mineral filler preferably selected from carbonates (including bicarbonates), phosphates, ferrocyanides, silica, silicates, aluminosilicates (including all forms of clay minerals and talc), titanium dioxide, and/or a carbon-based filler, or combinations thereof.
10. Polymer composite as claimed in any of the preceding clauses, wherein component d) is present in an amount from 1-40% by weight of the overall weight.
11. Polymer composite as claimed in any of the preceding clauses, comprising compatibilizers, fragrances, heat and UV stabilizers, and/or colouring agents or a mixture thereof as additive.
12. A process for preparing the polymer composite as claimed in any of the preceding clauses, wherein the polymer composite is made by hot compounding techniques, where the components are combined under heat and shearing forces that bring about a state of molten plastic (fluxing) which is shaped into the desired product, cooled and allowed to develop ultimate properties of strength and integrity, preferably by calendering, extrusion, injection and compression moulding.
13. The process of the preceding clause, carried out at temperatures in the range of 130 to 210° C.
14. The process of clause 12 or 13, carried out in two steps, forming an intermediate first in a first step and combining the intermediate with the remainder of the components in a second step.
15. A solid article comprising the polymer composite as claimed in any of the preceding clauses 1-11.
16. The solid article of the preceding clause, in the form of a compounded pellet, extruded work-piece, injection-moulded article, blow moulded article, film or rota-moulded plastic article, two-part liquid moulded article, laminate, 3D printer filament, felt, woven fabric, knitted fabric, embroidered fabric, nonwoven fabric, geotextiles, fibre or a solid sheet.
17. The solid article of clause 15 or 16, in the form of a coffee pod, cutlery, food tray, or single-serve packaging.
18. The solid article as claimed in any of the preceding clauses 15-17, comprising a polyolefin, preferably PP and/or PE, at a loading level of 1-30% w/w.
19. An intermediate as prepared by the process of clause 14, for use in the preparation of a polymer composite as claimed in any of the preceding clauses 1-11.

What is claimed is:

1. A polymer composite having an overall weight, comprising:
(a) a polymer in an amount of 1-99% by weight of the overall weight; and
(b) biscuit cereal meal (BCM) in an amount of at least 1% by weight of the overall weight.

2. The polymer composite of claim 1, wherein the polymer comprises a biodegradable polymer chosen from polyglycolide (PGA), polylactide, poly(lactic acid) (PLA), poly(lactide-co-glycolide) (PLGA), polycaprolactone (PCL), poly(butylene succinate) (PBS) and its copolymers, poly(butylene succinate-co-adipate) (PBSA), poly(butylene adipate-co-terephtalate) (PBAT), a linear copolymer of N-acetyl-glucosamine and N-glucosamine with β-1,4 linkage, cellulose acetate (CA), poly(hydroxybutyrate) (PHB), polyhydroxyalkanoates (PHA), poly(hydroxybutyrate-co-hydroxyvalerate) (PHBV), and mixtures, derivatives and polymer blends thereof.

3. The polymer composite of claim 1, wherein the polymer is present in an amount of 30-75% by weight of the overall weight.

4. The polymer composite of claim 1, wherein the biscuit cereal meal comprises 10-15% protein, 60-70% starch, and 0-5% sugar.

5. The polymer composite of claim 1, comprising a mixture of biscuit cereal meal and up to 100% w/w of biscuit cereal meal chosen from milled expeller/meal/cake, milled pomace, milled distillers' grain, milled brewer's grain, brewer's spent grain/draff, coffee grounds, milled whole seeds, milled whole roots, milled whole beans, milled stems and leaves, milled whole grain flour of cereal grass, flour of pulse, and mixtures thereof.

6. The polymer composite of claim 1, wherein the biscuit cereal meal is present in an amount of 30-70% by weight of the overall weight.

7. The polymer composite of claim 1, further comprising a plasticizer in an amount from 0-50% w/w of the biscuit cereal meal, wherein the plasticizer is chosen from polyols, polyfunctional alcohols, amphipolar plasticizers, carboxylic acids and esters, mono, di-, and tri-glyceride esters, mono-, di- and oligosaccharides, and mixtures thereof.

8. The polymer composite of claim 1, further comprising a plasticizer in an amount of 22-40% w/w of the biscuit cereal meal.

9. The polymer composite of claim 1, further comprising a filler chosen from a natural fibre, cellulose, lignocellulose fibres, a mineral filler, carbonates, bicarbonates, phosphates, ferrocyanides, silica, silicates, aluminosilicates, clay minerals, mica, talc, titanium dioxide, a carbon-based filler, and combinations thereof.

10. The polymer composite of claim 1, further comprising a filler in an amount of 1-40% by weight of the overall weight.

11. The polymer composite of claim 1, further comprising an additive, chosen from compatibilizers, fragrances, heat and UV stabilizers, colouring agents, and mixtures thereof.

12. A process for preparing a polymer composite comprising a polymer, and biscuit cereal meal as components, the process comprising combining the components under heat and shearing forces, forming thereby a molten plastic; shaping the molten plastic by a method chosen from calendering, extrusion, injection and compression moulding into a form; and cooling the form from said step of shaping the molten plastic for a time sufficient for generating strength and integrity in the form.

13. The process of claim 12, wherein said step of combining the components is carried out at temperatures in the range of 130 to 215° C.

14. The process of claim 12, comprising the steps of forming an intermediate from at least one component; and combining the intermediate with the previously unused components.

15. A solid article comprising a polymer and biscuit cereal meal.

16. The solid article of claim 15 having the form chosen from a compounded pellet, an extruded work-piece, an injection-moulded article, a blow moulded article, a rota-moulded plastic article, a two-part liquid moulded article, a laminate, a 3D printer filament, felt, woven fabric, knitted fabric, embroidered fabric, nonwoven fabric, geotextiles, a fibre, and a solid sheet.

17. The solid article of claim 15, having the form chosen from a coffee capsule, cutlery, a straw, a drink stirrer, a food tray, single-serve packaging, such as a cup, cap, container and container lid, and a single-use item.

18. The polymer composite of claim 3, wherein the polymer is present in an amount of 30-70% of the overall weight.

19. The polymer composite of claim 3, wherein the polymer is present in an amount of 30-50% by weight of the overall weight.

20. The polymer composite of claim 5, wherein the mixture is present in an amount of 30-70% by weight of the overall weight.
